(19) United States
(12) Patent Application Publication
(10) Pub. No.: US 2003/0140942 A1
(43) Pub. Date: Jul. 31, 2003

(54) Method and apparatus for treating a moving surface

(76) Inventors: Raimo Rajala, Kaarina (FI); Eino Harkonen, Koria (FI); Jouni Paltakari, Espoo (FI); Olli Asp, Turku (FI)

Correspondence Address: KUBOVCIK & KUBOVCIK, SUITE 710, 900 17TH STREET NW, WASHINGTON, DC, 20006

(21) Appl. No.: 10/220,733

(22) PCT Filed: Mar. 8, 2001
(86) PCT No.: PCT/FI01/00229

(30) Foreign Application Priority Data
Mar. 8, 2000 (FI) 20000532

(51) Int. Cl. B08B 7/00

(52) U.S. Cl. 134/6; 134/9; 134/33; 15/256.53; 15/256.5; 118/203; 451/178; 162/272

(57) ABSTRACT

A method for treating a moving surface, such as a rotating roller (11) or a moving belt (42), according to which method surface treatment elements (12), such as metallic brushes (12), are pressed against the surface to clean and smooth it. The brushes are cleaned at the edge of the surface. The brushes are connected to an endless chain (16) on which the brushes are moved in a transverse direction by a moving means (17). The apparatus may be mounted in conjunction with a roller or belt or connected to it via a doctor frame (31) or some other supporting structure (47).

### METHOD OF THE INVENTION

The present invention relates to a method for treating or cleaning a moving surface, such as a rotating roller, a moving belt or a similar surface, according to which method at least one surface treatment element is applied against the moving surface, said element being moved transversely with respect to the direction of motion of the surface, e.g. in the direction of the axis of the rotating roller or the axis of a roller supporting the moving belt.

### PRIOR-ART METHOD

It is known that rotating rollers in the calenders of paper machines, in glazing calenders, printing presses or equivalent tend to gather all sorts of impurities, such as e.g. paper dust, paper coating material or other material, from the paper web touching the roller surface, and these impurities may bum to the roller surface and adhere fast on it. In a printing press, e.g. printing ink may remain sticking to the roller. Because of such impurities, the rollers have to be cleaned regularly. If the roller surface is not cleaned, then the quality of the paper or other product being treated falls rapidly.

In prior-art paper machines, rotating rollers are cleaned by shaving the roller surfaces with special shaving plates called doctor blades. By scraping the roller surface, the doctor blades shave the impurities off the roller surface, the scrapings being thus accumulated on the blade In the calenders of paper and coating machines, the doctors usually consist of metallic or composite plastic blades shaving the roller surface. Doctor blades can be kept continuously in operation.

However, the use of doctor blades has the drawback that the doctor blade is subject to fast wear. This is because the blade is continuously rubbing against the surface of a metallic roller cylinder, which is usually made of steel. Often the wear of the doctor blade is nonuniform, with the result that the blade does not follow the roller surface accurately. As a consequence, the unevenly worn doctor blade may also damage the roller surface.

Another disadvantage with the use of doctor blades is that they do not always work reliably. In the drying section of a paper machine, glutinous matter tends to burn to the surface of the foremost cylinders, and this matter pushes in between the cylinder and the doctor blade, forcing the doctor blade to rise clear of the cylinder surface. As a result, the cylinder surface tends to become striped with streaks of impurities that cannot be removed by a doctor blade. It is also possible for chaff to get between the roller and the doctor blade, producing detrimental grooves on the roller surface to be cleaned. In this case, too, the doctor blade can no longer clean the roller, which therefore has to be removed from the paper machine for reconditioning.

Another disadvantage with the doctor knife is that the doctor blade as such cannot remove the impurities shaved off the roller. Dust and other dirt shaved off the roller is accumulated on the blade, from where it has to be removed by some means or other. In prior art, various suction ducts and other solutions are used. However, the impurities may still get between the doctor blade and the roller surface, where they may produce grooves in the roller surface.

In addition to doctor blades, various rotating cleaning means, such as e.g. rotary brushes, have been used for cleaning the surface of a rotating roller. Used together with moisturizing or dissolving agents, rotary brushes release from the rotating roller surface impurities that are sticky or otherwise difficult to remove. Since sticky materials adhere to the brush and would soon block it, a brush cleaning action performed regularly or continuously is implemented using e.g. jets of water or diluent. It is clear that if a large amount of sticky impurities is accumulated on the surface of a rotating roller, then an efficient cleaning device of some kind as described above will be necessary.

However, in a paper machine, in most cases the material accumulating on the roller surface mainly consists of impurity particles such as paper dust and pieces of paper of different sizes. They are held sticking to the surface of the rotating roller by the action of moisture and possible coating material added to the paper. If these impurities are not immediately removed from roller surface, they will cause definite harm. Some of the particles will be carried along with the paper web, impairing the paper quality, and some of these originally loose particles will soon burn fast to the surface of the rotating roller. because many rollers in the paper machine are very hot.

In present-day paper machines, however, no suitable methods or equipment are known that could be used for removing impurities like those described above from the surface of a rotating roller during production while the paper machine is running. The doctor blade generally used for cleaning the roller surface is too hard a means for this purpose, and the blade is subject to fast wear and also causes too much wear of the roller surface. Neither is the use of rotary brushes applicable for this purpose because a rotating brush does not bind any loose impurities in itself. A rotating brush would fling the particles released from the roller surface into the air, from where they would settle on the paper web as the machine is running, thus impairing the quality of the paper being produced. It is true that roller cleaning devices used to remove sticky impurities during an outage of the paper machine are usually provided with an encasement to allow washing of the brushes, but the encasement would not stop the dust from being flung from the rotating brush onto the paper web during production.

### OBJECT OF THE INVENTION

The object of the invention is to achieve a method for the treatment of a moving surface, such as a rotating roller or a similar surface, that does not have the disadvantages described above.

### FEATURES CHARACTERISTIC OF THE METHOD OF THE INVENTION

The method of the invention for treating a moving surface is characterized in that

at least one surface treatment brush or equivalent is moved across the moving surface, such as a rotating roller, a moving belt or a similar surface, in a direction transverse to the direction of motion of the surface, said brush being pressed against said surface,

while the brush is moving transversely across the moving surface, the bristles of the brush are kept pressed against the moving surface so that at least some of the bristles are subjected to a longitudinal compression stress,

and that the surface treatment brush is passed over the edge of the moving surface so that the bristles are released from the longitudinal compression stress.

By the method of the invention, a moving surface can be treated in many different ways.

The surface can be e.g. cleaned, ground, oxidized or coated, as will be described below.

Another possibility is to press against the moving surface a surface treatment element which, instead of a brush, consists of e.g. felt, net or other elastic material that is capable of treating the surface or releasing impurities from the moving surface and/or gathering loose impurities and dust into itself, which can then be removed from the moving surface to a position outside it by means of the surface treatment element.

### EMBODIMENTS OF THE METHOD OF THE INVENTION

A preferred embodiment of the method of the invention for the treatment of a moving surface is characterized in that the moving surface, such as a rotating roller or a moving belt, is cleaned by means of a surface treatment brush as follows:

possible impurities are released from the moving surface by means of a brush moving transversely across the surface,

loose impurity particles present on the surface and the particles released from the surface are engaged between the bristles of the brush,

said particles are carried between the bristles of the brush toward the edge of the moving surface and further over the edge, and

said impurity particles are removed from the bristles of the brush outside the edge of the moving surface.

A second embodiment of the method of the invention for the treatment of a moving surface is characterized in that the impurity particles are removed from the brush moving transversely across the moving surface at the edge of the moving surface by causing the impurity particles to be flung off the bristles by the straightening motion taking place as the bent bristles are released from the compression stress applied against the moving surface.

When the method of the invention for treating a surface is used to clean a moving surface, the bristles pressed against the surface loosen impurities from the surface. The loosened material, such as paper dust, then sticks between the bristles of the brush and is carried with the brush toward the edge of the moving surface. As the points of the bristles are held continuously pressed against the moving surface, at least some of the bristles are subjected to a longitudinal compression stress, causing bending of the bristles. As the bristles move further over the edge of the moving surface, they are released from the stress. At the same time, the bristles which had been bent under the stress straighten out suddenly, flinging the impurities carried with the bristles off the brush away from the moving surface, such as a rotating roller. Alternatively, the bristles may also be passed over some other threshold to rid them of the impurities. Another possibility is to use e.g. compressed air to clean the bristles. In this case, the impurity particles removed from the bristles are emitted into the ambient air in the vicinity of the end of the roller or the edge of the belt, but the impurity particles can also be carried away via a suitable duct if necessary.

A third preferred embodiment of the method of the invention for the treatment of a moving surface is characterized in that the moving surface, such as a rotating roller or a moving belt, is abraded by means of a metallic surface treatment brush as follows:

the points of the metallic bristles of the brush moving transversely across the moving surface are pressed against the moving surface,

the particles released from the moving surface and sticking to the bristles are carried between the bristles toward the edge of the moving surface and further over the edge, and

the particles sticking to the bristles are removed from the bristles outside the edge of the moving surface.

According to the invention, by using a metallic brush, the surface can be both cleaned and abraded, so that the surface is smoothed at the same time by cutting off roughness peaks and by filling pits.

A fourth preferred embodiment of the method of the invention for the treatment of a moving surface is characterized in that

the moving surface, such as a rotating roller or a moving belt, is abraded by means of a metallic surface treatment brush advancing transversely across the moving surface, and

the points of the metallic bristles of the brush are pressed against the moving surface so that the friction caused by the abrasion produces heat, which again causes oxidation in the moving surface.

The abrasion between the metallic brush and the moving surface produces heat, causing changes in the structure of the oxide layer of the surface. As a result, the moving surface becomes smoother, more wear resistant and is more likely to remain clean. The material of the metallic brush is e.g. steel, stainless steel, brass or bronze.

The abrasion method of the invention using a metallic brush can at least partially replace the grinding of the rollers of a paper machine, which in a prior-art method is performed using abrasive paper belts. However, abrasive paper can only be used as long as its grinding edges remain in a good cutting condition. The wear and clogging of abrasive paper increase the friction between the abrasive paper and the roller being ground, further heating the surface being ground. As a result, the surface layer of the roller becomes harder and is liable to being cracked.

A fifth preferred embodiment of the method of the invention for the treatment of a moving surface is characterized in that

the moving surface, such as a rotating roller or a moving belt, is abraded by means of a plastic surface treatment brush advancing transversely across the moving surface, that

the points of the plastic bristles of the brush are pressed against the moving surface so that the friction caused by the abrasion produces heat, which again causes partial melting or softening of the points of the bristles, and that

part of the molten or softened material of the points of the bristles is transferred to the moving surface and used for coating the latter.

According to the method of the invention, a plastic brush is pressed against the moving surface and plastic material is transferred from the brush to the moving surface as a result of abrasion. Thus, the moving surface can be coated with a thin plastic layer, the material of which is e.g. teflon.

### APPARATUS OF THE INVENTION

The invention also relates to a surface treatment apparatus for treating or cleaning a moving surface, such as a rotating roller, a moving belt or an equivalent surface, said apparatus comprising at least one surface treatment element to be applied against the moving surface and means for moving the surface treatment element transversely with respect to the direction of motion of the surface, e.g. in the direction of the axis of the rotating roller or the axis of a roller supporting the moving belt.

### FEATURES CHARACTERISTIC OF THE APPARATUS OF THE INVENTION

The apparatus of the invention is characterized in that the surface treatment apparatus comprises

at least one surface treatment brush having bristles of elastic material

means for pressing the points of the bristles of the surface treatment brush against the moving surface,

means for moving the surface treatment brush transversely across the moving surface and further outside the moving surface so that the bristles of the surface treatment brush are released from contact with the moving surface.

The surface treatment element pressed against the moving surface may also consist of e.g. felt, net or other material capable of releasing impurities from the moving surface and/or gathering loose impurities and dust, which can then be removed away from the moving surface by means of the surface treatment element

The bristles of the surface treatment brush pressed against the moving surface are made of a metallic material, such as stainless steel or brass, plastic or from natural bristles obtained from animals or plants. The essential point is that the bristles are made of a material having at least some elasticity and are also capable of loosening and/or gathering impurities and dust as well as removing them.

The surface treatment brush of the invention can be effectively applied in many different uses. It is applicable for the cleaning, abrasion, oxidation and coating of a surface, as will be described below. A brush also involves fewer problems than e.g. a doctor blade. The elasticity of the brush permits larger installation tolerances. Besides, the wear of an elastic brush causes no problems because a contact with the moving surface is maintained regardless of wear. The brush is therefore applicable in continuous operation. The bristles of the brush can also get into grooves in the moving surface, such as e.g. a rotating roller.

### EMBODIMENTS OF THE APPARATUS OF THE INVENTION

A preferred embodiment of the apparatus of the invention for the treatment of a moving surface is characterized in that the surface treatment apparatus comprises at least one metallic brush which can be moved transversely across the moving surface and has metallic bristles, the points of which can be pressed against the moving surface to clean, abrade or oxidize said surface.

A second preferred embodiment of the surface treatment apparatus of the invention is characterized in that the surface treatment apparatus comprises at least one plastic brush which can be moved transversely across the moving surface and has plastic bristles, the points of which can be pressed against the moving surface to clean or coat said surface.

A third preferred embodiment of the surface treatment apparatus of the invention is characterized in that

the brushes of the surface treatment apparatus are attached to an endless loop, such as a chain, by means of which the brushes can be moved transversely across the moving surface and further beyond the edge of the surface, and that

in the return path of the brushes in the endless loop, the brushes move in the opposite direction across the moving surface and further over the opposite edge.

A fourth preferred embodiment of the surface treatment apparatus of the invention is characterized in that the brushes attached to an endless chain are in contact with the moving surface during their movement in one direction or during their movement in both directions.

A fifth preferred embodiment of the surface treatment apparatus of the invention is characterized in that the brushes attached to an endless chain are in contact with one moving surface or simultaneously with two moving surfaces, such as two adjacent rollers.

A sixth preferred embodiment of the surface treatment apparatus of the invention is characterized in that the brushes attached to an endless chain can be alternately brought into contact with two moving surfaces, such as two adjacent rollers.

A seventh preferred embodiment of the surface treatment apparatus of the invention is characterized in that the direction of motion of the brushes attached to an endless chain can be reversed.

An eighth preferred embodiment of the surface treatment apparatus of the invention is characterized in that the surface treatment apparatus comprises a device for cleaning the surface treatment brushes, said device comprising an air jet and a chaff collecting means, said cleaning device being placed at one end of the moving surface, such as a roller, or at an edge of a moving belt.

A ninth preferred embodiment of the surface treatment apparatus of the invention is characterized in that the surface treatment apparatus is a separate unit which can be mounted as such in the vicinity of any moving surface or in conjunction with an existing device, such as a doctor blade on a roller.

A tenth preferred embodiment of the surface treatment apparatus of the invention is characterized in that the moving means of the surface treatment apparatus comprises an actuator consisting of an electric device, a pneumatic cylinder or equivalent which moves the endless chain and the surface treatment brushes attached to it on the moving surface. The slide surfaces of the pneumatic cylinder may be made of a ceramic material, in which case the moving means will need no lubrication at all. A lubricant could stain e.g. paper being produced in a paper machine.

An eleventh preferred embodiment of the surface treatment apparatus of the invention is characterized in that the bristles of the brush of the surface treatment apparatus are made of a metallic material, such as steel, stainless steel, brass, a synthetic material, such as plastic, e.g. teflon, or from natural bristles, such as bristles obtained from animals or plants.

The brush has the advantage that it can effectively release impurities from the moving surface, clean the surface, smooth rough areas in the surface and bind in itself the material and loose chaff removed from the surface, which material and chaff can then be removed with the brush away from the surface. The brush can also be easily cleaned outside the moving surface, whereupon the brush is again brought into contact with the moving surface. By using a metallic brush, besides cleaning the surface it is also possible to produce an effect smoothing, hardening, and glazing the moving surface and keeping it clean. By using a plastic brush, made of e.g. teflon, besides a cleaning effect additionally a coating and lubricating effect is produced on the moving surface.

An essential feature of the surface treatment apparatus of the invention is that it can be used in process, e.g. while paper production is going on. Thus, the apparatus remains continuously mounted in conjunction with a roller e.g. in a paper machine instead of being only mounted e.g. during servicing shutdowns.

### EXAMPLES OF EMBODIMENTS

In the following, the invention will be described by the aid of examples with reference to the attached drawings, wherein

### LIST OF ILLUSTRATIONS

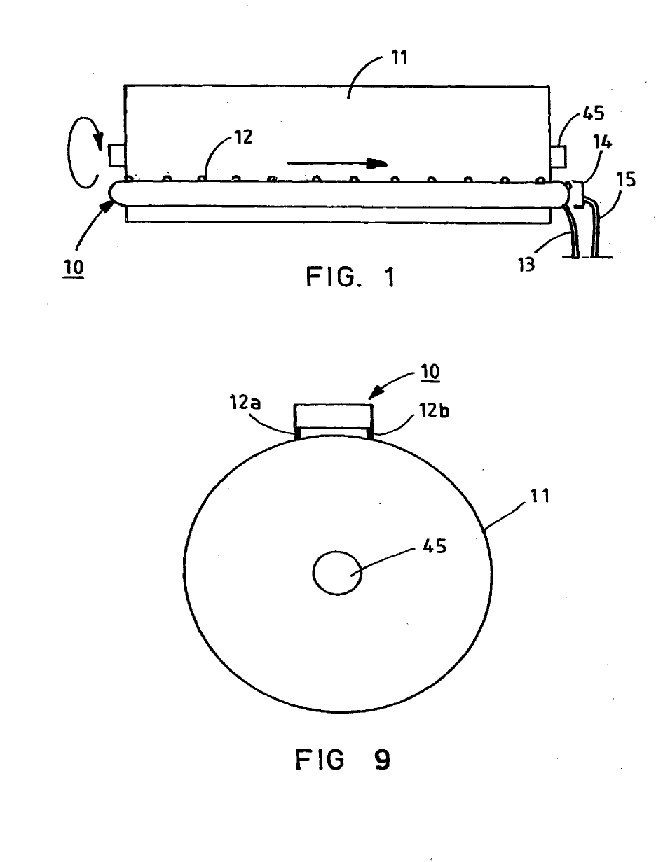

FIG. 1 presents a diagrammatic top view of a rotating roller and an apparatus according to the invention for the treatment of the roller surface.

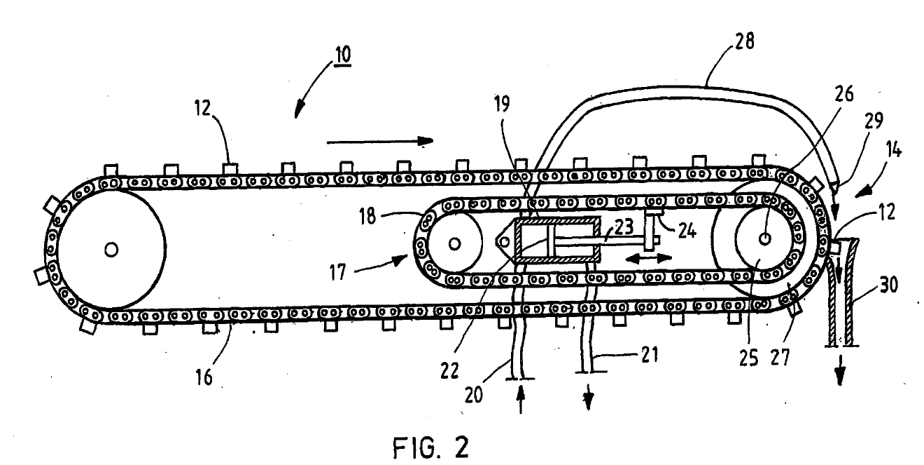

FIG. 2 presents a diagrammatic top view of the structure of the apparatus of FIG. 1.

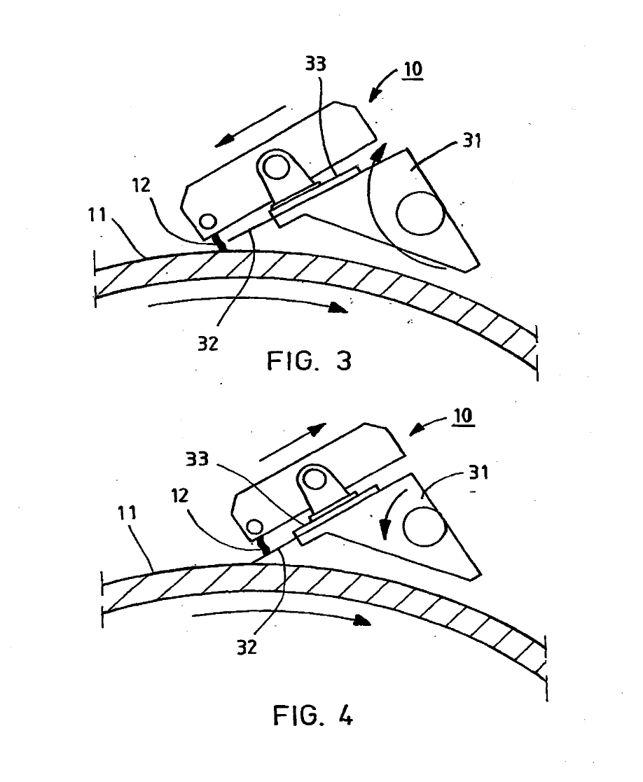

FIG. 3 presents a lateral view of a surface treatment apparatus according to the invention, used together with a doctor on a rotating roller.

FIG. 4 corresponds to FIG. 3 and presents a surface treatment apparatus used together with a doctor, in a second position.

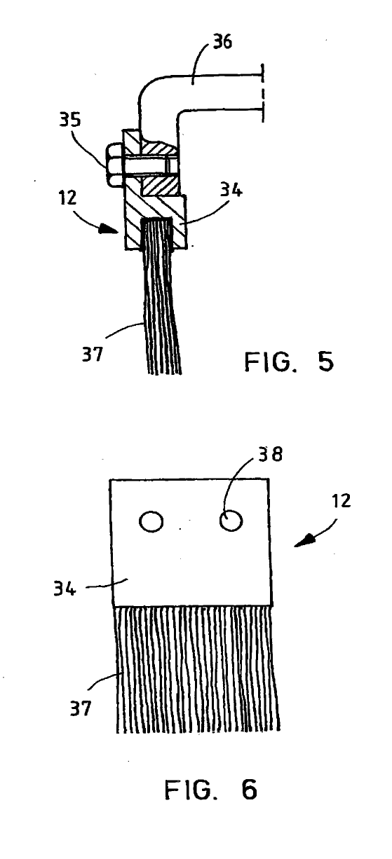

FIG. 5 presents a partially sectioned lateral view of a surface treatment brush as used in the apparatus of the invention.

FIG. 6 presents a front view of the surface treatment brush shown in FIG. 5.

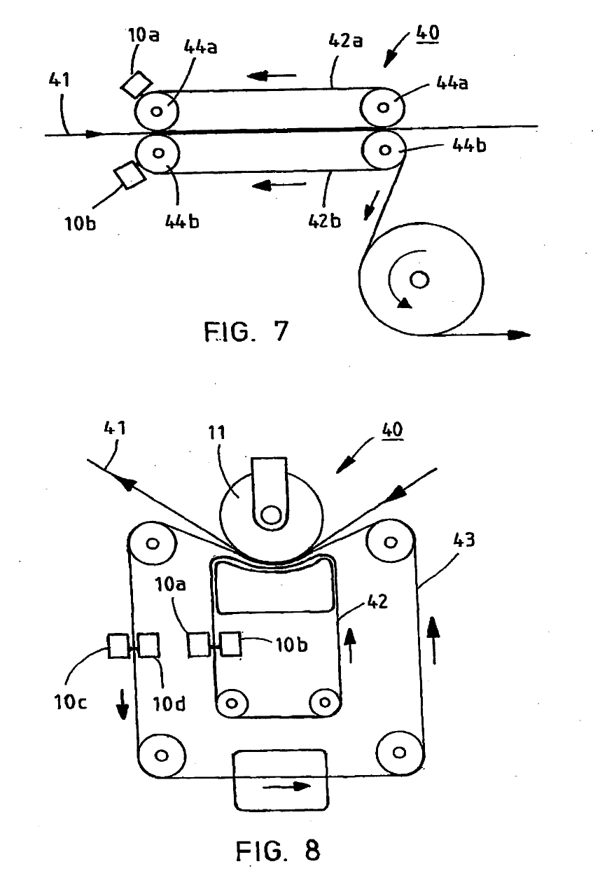

FIG. 7 presents a diagrammatic side view of surface treatment apparatus according to the invention, mounted in conjunction with moving belts.

FIG. 8 presents a diagrammatic view of a second surface treatment apparatus with surface treatment brushes mounted in conjunction with a moving belt.

FIG. 9 presents a diagrammatic view of a surface treatment apparatus according to the invention, mounted on a roller and seen from the end of the roller.

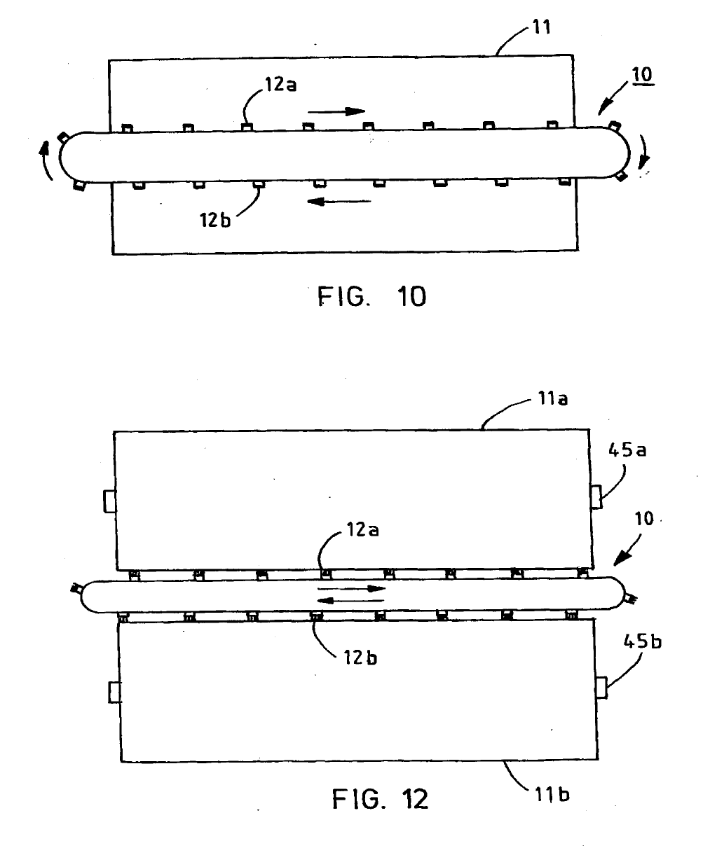

FIG. 10 presents a diagrammatic view of the roller in FIG. 10 and the surface treatment apparatus of the invention in top view.

FIG. 11 presents a diagrammatic view of the surface treatment apparatus of the invention, mounted between two rollers and seen from the ends of the rollers.

FIG. 12 presents a diagrammatic top view of the rollers and the surface treatment apparatus of the invention shown in FIG. 11.

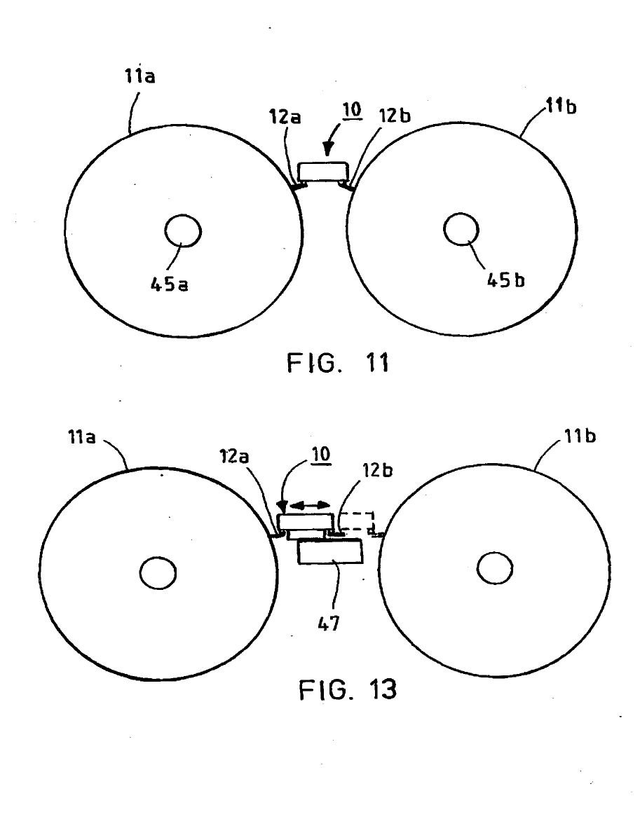

FIG. 13 corresponds to FIG. 11 and presents a diagrammatic view of a surface treatment apparatus according to the invention which can be moved between the rollers, seen from the ends of the rollers.

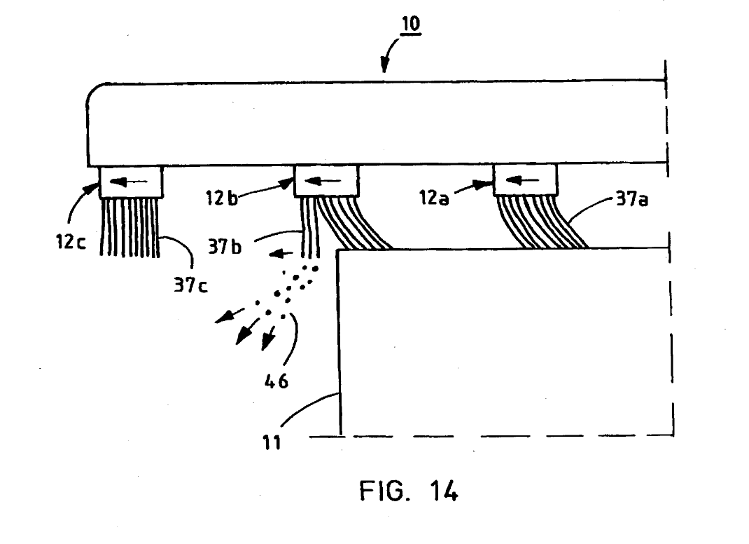

FIG. 14 presents diagrammatic side view of part of the end of a roller and part of a surface treatment apparatus according to the invention.

### DESCRIPTION OF ILLUSTRATIONS

FIG. 1 presents a rotating roller 11, which is e.g. a drying cylinder in a paper machine. Mounted in conjunction with the roller 11 is a surface treatment apparatus 10 comprising a number of brushes 12. The brushes 12 are pressed against the surface of the roller 11 and connected to an endless chain in a device for moving the brushes 12. The brushes 12 connected to the endless chain move in the direction of the axis of the roller 11, to the right in FIG. 1. Connected to one end of the apparatus 10 is a pneumatic hose 13 for supplying compressed air to drive the endless chain of the device moving the brushes 12. Furthermore, mounted at the end of the apparatus 10 is a cleaning device 14 for cleaning the brushes 12, in which the brushes 12 are cleaned by the compressed air exhausted from the brush moving device. The chaff released from the brushes 12 is removed through a hose 15.

FIG. 2 illustrates the structure of the apparatus 10 for treating the surface of a rotating roller. The brushes 12 are connected to an endless chain 16 driven by a moving means 17. The moving means 17 comprises another endless chain 18, which is driven by a pneumatic cylinder 19. The cylinder 19 is supplied with compressed air via hoses 20 and 21 by using a control valve, which is not shown in FIG. 2, to direct the compressed air alternately to opposite sides of the piston 22. This causes the piston 22 and the piston rod 23 to reciprocate. The piston rod 23 is connected to the chain 18 via a connecting piece 24, so when the piston 22 is moving, the endless chain 18 of the moving means 17 is also moving to and from.

In the apparatus 10 presented in FIG. 2, the endless chain 18 of the moving means 17 is passed over a chain sprocket 25. Mounted on the same shaft 26 with the sprocket 25 is another chain sprocket 27, over which the endless chain 16 carrying the brushes 12 is passed. Between the sprockets 25 and 27 there Is a dummy coupling, which is not shown in detail in FIG. 2. By using a dummy coupling, the reciprocating motion imparted from the piston 22 to chain 18 can be converted into a unidirectional motion of chain 16. In this way, the brushes 12 are made to brush the cylinder surface continuously in the same direction.

The thrust motion of the piston 22 to the right in FIG. 2 is retarded by a control valve so that the velocity of chain 16 and therefore that of the brushes 12 will be slow enough, e.g. about 1 m/min., whereas the return motion of the piston 22 in the reverse direction is substantially faster. This motion can be made so fast that the air exhausted from the cylinder 19 via hose 28 can be used to produce an effective air blast impulse from a jet 29 in the cleaning device 14 to clean the brush 12 under the jet. Chaff removed from the brush 12 is carried away via a hose 30.

Alternatively, the endless chain 16 carrying the brushes 12 in FIG. 2 is driven by an electric motor, which is not shown in the drawings. In this case, the motion of the chain 16 can be adjusted to an appropriate level by using a suitable reduction gear or by adjusting the rotational speed of the electric motor. An electric motor drive provides the advantage that the direction of motion of the chain 16 and therefore of the brushes 12 can be easily changed. A change of direction may be necessary e.g. when a brush 16 has caught a body that does not come off from the brush 16 at the end of the roller or at the edge of the belt. In such a case, a change of direction of motion of the brush 16 may cause this body to come off.

The electric motor and the reduction gear naturally have to be completely leakproof so that e.g. no oil can leak from them onto the moving surface or paper web. The electric motor drive can be implemented in the same size as the pneumatic moving means 17 presented in FIG. 2. In this case, the electric motor drive and the pneumatic moving means 17 are interchangeable components.

FIG. 3 presents an apparatus 10 for treating the surface of a roller 11, mounted on the frame 31 of a doctor via guide rails 33. The apparatus 10 can be moved on the guide rails 33 to the left in FIG. 3 so as to bring the brushes 12 into contact with the surface of the roller 11. In the position shown in FIG. 3, the doctor frame 31 has been turned in the clockwise direction so that the doctor blade 32 is not in contact with the surface of the roller 11. Thus, only the apparatus 10 for treating the surface of the roller 10 is active while the doctor blade 32 is not.

FIG. 4 presents a situation where the apparatus 10 for treating the surface of a roller 11 has been moved on the guide rails 33 of the doctor frame 31 to the right and the doctor frame 31 has been rotated anti-clockwise so that the doctor blade 32 touches the surface of the roller 11. In this case, the doctor blade 32 is active, shaving the surface of the roller 11. In this situation, the apparatus 10 can be used for cleaning the doctor blade 32 when necessary.

In FIG. 3 and 4, the surface treatment apparatus 10 is mounted on the doctor frame 31, but it can just as well be mounted on some other supporting structure, as illustrated in FIG. 13

FIG. 5 presents a replaceable brush 12 as used in the apparatus 10 for treating the surface of a roller 11, the frame 34 of the brush being fastened with bolts 35 to a connecting piece 36 which connects the brush 12 to the endless chain 16 of the apparatus 10. The metallic bristles 37 are fastened to the frame 34 of the brush 12 by a reliable method known in, itself, e.g. by gluing, crimping or by a similar method.

FIG. 6 presents a replaceable brush 12 of the apparatus 10 for treating the surface of a roller 11, in front view, showing a frame 34 with holes 38 for bolts and a dense array of bristles 37 attached to the frame 34.

FIG. 7 presents a diagrammatic side view of a papery dryer 40 in which a paper web 41 is passed between two endless belts 42a and 42b and between their supporting rollers 44a and 44b. One of the belts 42 and 42b is hot and the other is cold. In this device known in itself, each belt 42a, 42b is provided with a surface treatment apparatus 10a, 10b corresponding to those presented in the previous figures, in which they were installed on rollers 11.

FIG. 8 presents another paper dryer 40, in which the paper web 41 is passed between a roller 11 and an endless metallic belt 42, which press the paper web between them. Between the paper web 41 and the metallic belt, a felt 43 is provided. In this paper dryer 40, a surface treatment apparatus 10a and 10b according to the invention is placed on each side of the endless metallic belt 42.

FIG. 9 presents a surface treatment apparatus 10 installed in conjunction with a rotating roller 11 and having brushes 12 connected to an endless chain. On one side of the surface treatment apparatus 10, the brushes 12a move in one direction parallel to the axis 45 of the roller 11, while on the opposite side of the surface treatment apparatus 10 the brushes 12b move in the opposite direction parallel to the axis 45 of the roller 11. As the surface treatment apparatus 10 in FIG. 9 is of a symmetrical design, it can be so installed in conjunction with the roller 11 that the brushes 12a and 12b moving in both directions are in contact with the surface of the roller 11.

FIG. 10 presents the roller 11 of FIG. 9 and the surface treatment apparatus 10 used together with it in top view. As shown in the figure, the brushes 12 connected to the endless chain move on the surface of the roller 11 in different directions on opposite sides of the surface treatment apparatus 10. The brushes 12a and 12b moving in both directions are used for treating and cleaning the surface of the roller 11. The essential point about the surface treatment apparatus 10 is that the brushes 12 advance at both ends of the roller 11 clearly beyond the end faces of the roller 11. In this way, the compressive stress applied to the brushes 12 during the surface treating movement by the surface of the roller 11 can be released outside the end faces of the roller 11 and the brushes can be cleaned, as described below.

FIG. 11 presents a surface treatment apparatus 10 placed between two rollers 11a and 11b. As the surface treatment apparatus 10 has on both sides of it brushes 12a and 12b connected to an endless chain and moving in opposite directions, they can be used simultaneously for treating the surfaces of the rollers 11a and 11b on either side of the surface treatment apparatus 10. FIG. 12 shows the rollers 11a and 11b of FIG. 11 and the surface treatment apparatus 10 in top view.

FIG. 13 presents an embodiment in which the surface treatment apparatus 10 is placed between two rollers 11a and 11b and fastened to a supporting beam 47. However, the surface treatment apparatus 10 is movable so that it can be used alternately for treating the surface of one of the rollers 11a and 11b, and these may just as well be mounted e.g. one over the other. In a paper machine, the surface treatment apparatus 10 of FIG. 13 is changed from one roller to the other during a shutdown.

FIG. 14 presents the end of a roller 11 and part of a surface treatment apparatus 10. The figure shows three surface treatment brushes 12a, 12b and 12c of the surface treatment apparatus 10, each in a different functional situation, clearly illustrating the operating principle of the surface treatment brushes 12. All the surface treatment brushes 12a, 12b and 12c are moving to the left in FIG. 14. Brush 12a represents a surface treatment brush treating or cleaning the surface of the roller 11, with the bristles 37a pressed against the surface of the roller 11. The bristles 37a are now subject to a stress and in a somewhat bent position. In this situation, the bristles 37a loosen impurities from the surface of the roller 11, which impurities stick to the bristles 37a and are carried along with them toward end of the roller 11.

In FIG. 14, brush 12b represents a situation where the bristles 37b pressed against the surface of the roller 11 and subject to stress are moving over the edge of the roller 11. At this point, the bent bristles 37b are released from their stressed state and spring with a fast movement into a straight position. At the same time, the dust particles and other impurities carried with the bristles 37b are removed from the bristles and flung in a direction away from the roller 11 as a consequence of this intensive movement of the bristles 37b.

In FIG. 14, the next brush 12c represents a brush which has already moved past the end face of the roller 11 and whose bristles 37c have been cleaned in the above-described manner. At the end of the surface treatment apparatus 10, the brush 12c connected to the endless chain turns and starts moving in the opposite direction, in other words, the brush 12c performs a return motion. According to the alternatives described above, the brush 12c may move idle to the other end of the surface treatment apparatus 10 or it may be performing surface treatment even during this motion.

In view of the examples presented above, it is obvious to the person skilled in the art that different embodiments of the invention may vary greatly. It is further obvious that surface treatment apparatuses as provided by the invention can be used in a wide variety of applications for treating or cleaning a moving surface.

1. Method for treating or cleaning a moving surface, such as a rotating roller (11), a moving belt (42) or a similar surface, according to which method at least one surface treatment element (12) is applied against the surface and moved transversely with respect to the direction of motion of the surface, e.g. in the direction of the axis of the rotating roller or the axis of a roller supporting the moving belt, characterized in that
at least one surface treatment brush or equivalent is moved across the moving surface, such as a rotating roller (11), a moving belt (42) or a similar surface, in a direction transverse to the direction of motion of the surface, said brush being pressed against said surface,
while the brush is moving transversely across the moving surface, the bristles of the brush are kept pressed against the moving surface so that at least some of the bristles are subjected to a longitudinal compression stress,
and that the surface treatment brush is passed over the edge of the moving surface so that the bristles are released from the longitudinal compression stress.

2. Surface treatment method as defined in claim 1, characterized in that the moving surface, such as a rotating roller or a moving belt, is cleaned by means of a surface treatment brush so that
possible impurities are released from the moving surface by the brush moving transversely across the surface,
loose impurity particles present on the surface and the particles released from the surface are engaged between the bristles of the brush,
said particles are carried between the bristles of the brush toward the edge of the moving surface and further over the edge, and that
said impurity particles are removed from the bristles of the brush outside the edge of the moving surface.

3. Surface treatment method as defined in claim 2, characterized in that the impurity particles are removed from the brush moving transversely across the moving surface at the edge of the moving surface by causing the impurity particles to be flung off the bristles by their straightening motion taking place as the bent bristles are released from the compression stress applied against the moving surface.

4. Surface treatment method as defined in claim 2 or 3, characterized in that the moving surface, such as a rotating roller or a moving belt, is abraded by means of a metallic surface treatment brush as follows:
the points of the metallic bristles of the brush moving transversely across the moving surface are pressed against the moving surface,
the particles released from the moving surface and sticking to the bristles are carried between the bristles toward the edge of the moving surface and further over the edge, and
the particles clinging to the bristles are removed from the bristles outside the edge of the moving surface.

5. Surface treatment method as defined in claim 1, characterized in that
the moving surface, such as a rotating roller or a moving belt, is abraded by means of a metallic surface treatment brush,
and that the points of the metallic bristles of the brush are pressed against the moving surface so that the friction caused by the abrasion generates heat, which produces oxidation in the moving surface.

6. Surface treatment method as defined in claim 1, characterized in that
the moving surface, such as a rotating roller or a moving belt, is abraded by means of a plastic surface treatment brush advancing transversely across the moving surface, that
the points of the plastic bristles of the brush are pressed against the moving surface so that the friction caused by the abrasion generates heat, which causes partial melting or softening of the points of the bristles, and that
part of the molten or softened material of the points of the bristles is transferred to the moving surface and used for coating the latter.

7. Surface treatment apparatus (10) for coating or cleaning a moving surface, such as a rotating roller (11), a moving belt (42) or a similar surface, said apparatus comprising at least one surface treatment element (12) to be applied against the moving surface (11, 42) and means for moving the surface treatment element transversely relative to the direction of motion of the surface, e.g. in the direction of the axis (45) of the rotating roller or the axis of a roller (44) supporting the moving belt, characterized in that the surface treatment apparatus (10) comprises
at least one surface treatment brush (12) having bristles (37) made of an elastic material,
means for pressing the points of the bristles (37) of the surface treatment brush (12) against the moving surface (11, 42),
means for moving the surface treatment brush (12) transversely across the moving surface (11, 42) and further outside the surface so that the bristles (37) of the surface treatment brush are disengaged from the moving surface.

8. Surface treatment apparatus (10) as defined in claim 7, characterized in that, the surface treatment apparatus comprises at least one metallic brush which can be moved transversely across the moving surface and has metallic bristles, the points of which can be pressed against the moving surface to clean, abrade or oxidize said surface.

9. Surface treatment apparatus (10) as defined in claim 7, characterized in that the surface treatment apparatus comprises at least one plastic brush which can be moved transversely across the moving surface and has plastic bristles, the points of which can be pressed against the moving surface to clean or coat said surface.

10. Surface treatment apparatus (10) as defined in claim 7, 8 or 9, characterized in that
the brushes of the surface treatment apparatus are attached to an endless loop, such as a chain, by means of which the brushes can be moved transversely across the moving surface and further beyond the edge of the surface, and that
in the return path of the brushes in the endless loop, the brushes move in the opposite direction across the moving surface and further over the opposite edge.

11. Surface treatment apparatus (10) as defined in claim 10, characterized in that its brushes attached to an endless chain are in contact with the moving surface during their movement in one direction or during their movement in both directions.

12. Surface treatment apparatus (10) as defined in claim 10 or 11, characterized in that its brushes attached to an endless chain are in contact with one moving surface or simultaneously with two moving surfaces, such as two adjacent rollers.

13. Surface treatment apparatus (10) as defined in claim 10 or 11, characterized in that its brushes attached to an endless chain can be alternately brought into contact with two moving surfaces, such as two adjacent rollers.

14. Surface treatment apparatus (10) as defined in any one of claims 10-13, characterized in that the direction of motion of its brushes attached to an endless chain can be reversed.

15. Surface treatment apparatus (10) as defined in any one of claims 7-14, characterized in that the surface treatment apparatus (10) comprises a device for cleaning the surface treatment brushes (12), said device comprising an air jet and a chaff collecting means, said cleaning device being placed at one end of the moving surface, such as a roller (11), or at the edge of a moving belt (42).

16. Surface treatment apparatus (10) as defined in any one of claims 7-15, characterized in that the surface treatment apparatus (10) is a separate unit which can be mounted as such in the vicinity of any moving surface (11, 42) or in conjunction with an existing device, such as a doctor blade (32) on a roller (11).

17. Surface treatment apparatus as defined in any one of claims 7-16, characterized in that the moving means (17) of the surface treatment apparatus (10) comprises an actuator (19) consisting of an electric device, a pneumatic cylinder or equivalent, which moves the endless chain (16) and the surface treatment brushes (12) attached to it along the moving surface (11, 42).

18. Surface treatment apparatus (10) as defined in any one of claims 7-17, characterized in that the bristles (37) of the brush of the surface treatment apparatus (10) are made of a metallic material, such as steel, stainless steel, brass, a synthetic material, such as plastic, e.g. teflon, or from natural bristles, such as bristles obtained from animals or plants.
